(19) United States
(12) Patent Application Publication
(10) Pub. No.: US 2007/0065591 A1
(43) Pub. Date: Mar. 22, 2007

(54) Methods of preventing protein fouling and compositions therefor

(75) Inventor: Ashok Neil Parbhu, Petone, Wellington (AU)

Correspondence Address: DANN, DORFMAN, HERRELL & SKILLMAN, 1601 MARKET STREET, SUITE 2400, PHILADELPHIA, PA, 19103-2307, US

(73) Assignee: INDUSTRIAL RESEARCH LIMITED, Parnell, Auckland (NZ)

(21) Appl. No.: 10/558,234

(22) PCT Filed: May 21, 2004
(86) PCT No.: PCT/NZ04/00098

§ 371 Date: Oct. 2, 2006

(30) Foreign Application Priority Data
May 23, 2003 (NZ) 526113

(51) Int. Cl. B05D 3/02; C09D 1/00

(52) U.S. Cl. 427/384; 106/287.16; 106/287.1; 106/286.7; 106/600

(57) ABSTRACT

Methods and compositions for preventing protein fouling on surfaces are described. Such methods are particularly, but not exclusively, of use in treatment of stainless steel present in processing equipment such as in the dairy industry.

### FIELD

The present invention relates to novel methods and compositions for preventing protein fouling on surfaces particularly, but not exclusively, stainless steel surfaces. The invention is applicable to prevention of protein fouling of the surfaces of equipment used for example in food processing, particularly in the dairy industry.

### BACKGROUND

Protein adsorption onto surfaces, particularly stainless steel surfaces, is a major contribution to fouling problems in industrial plant, for example in the dairy industry. The formation of fouling deposits within such plants can be a severe problem which limits plant operation and product safety as has been noted, for example, within the New Zealand dairy industry (Impact and control of fouling in milk processing, P. de Jong, Trends in Food Science and Technology, December 1997 volume 8). Such fouling may also have an effect on product yield which may be measured on the basis of protein content.

Problems with protein fouling may also arise in the biotechnology industry, for example during large scale fermentation reactions or recombinant protein production.

As a result of such fouling, achieving effective cleaning and disinfection, and assuring cleanliness, is a major concern. Efforts to address such fouling generally focus on cleaning and disinfection techniques. There may be disadvantages to cleaning and disinfection techniques as they involve removal of fouling on a regular basis, which may disrupt processing, for example.

Bibliographic details of the publications referred to herein are collected at the end of the description.

### OBJECT

It is an object of the present invention to provide a method and compositions for preventing protein fouling of surfaces, particularly stainless steel surfaces.

### STATEMENT OF INVENTION

In a first aspect of the invention there is provided a method for preventing protein fouling of a surface comprising at least the step of placing in contact with the surface a composition comprising silicate to allow a silicate coating to form on the surface.

Preferably, the composition has a pH between approximately 6 to approximately 10. More preferably, the composition has a pH of 7.

Preferably, the composition has a calculated silicate concentration from approximately 0.04M to 0.8M. More preferably, the the composition has a calculated silicate concentration of approximately 0.08M.

Preferably, the composition and the surface are placed in contact at a temperature of between approximately 10° C. to approximately 120° C. More preferably, the composition is placed in contact with the surface at ambient temperature.

Preferably, the composition is allowed to remain in contact with the surface for a period of time sufficient to allow coating of the surface with silicate. More preferably, the composition is allowed to remain in contact with the surface for a period of at least from approximately 20 minutes to approximately 60 minutes. More preferably, the composition is allowed to remain in contact with the surface for a period of at least approximately 30 minutes.

Preferably, the surface is constructed of a metal oxide, more preferably stainless steel. Preferably, the surface is on equipment used in the dairy industry.

Preferably, the method further comprises the step of washing said composition from said surface after contact (or washing the composition from contact with the surface). Preferably, water is used to wash the composition from contact with the surface.

Preferably, the method is for preventing protein fouling by a composition containing one or more proteins. Preferably, the composition containing one or more proteins is milk.

In another aspect, the invention provides a method of processing a composition containing one or more proteins, the method comprising at least the steps of:
a) preparing a surface of any equipment in accordance with a method of the invention as hereinbefore described; and,
b) processing with the equipment the composition containing one or more proteins.

In another aspect, the invention provides the use of silicate in the manufacture of a composition for the prevention of protein fouling on a surface.

Preferably an amount of silicate is sufficient to provide a calculated silicate concentration in the composition from between approximately 0.04M to approximately 0.8M. More preferable the amount of silicate is sufficient to provide a calculated silicate concentration in the composition of approximately 0.08M.

Preferably, at least approximately 0.05% to approximately 10% silicate is used. More preferably, approximately 1% silicate is used.

Preferably the silicate is sodium silicate.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

### FIGURES

These and other aspects of the present invention, which should be considered in all its novel aspects, will become apparent from the following description, which is given by way of example only, with reference to the accompanying figures, in which:

FIG. 1: Illustrates the amount of coverage of silicate on mica samples versus pH of Na₂SiO₃ solution.

FIG. 2: Illustrates the amount of coverage of silicate on stainless steel samples vs pH of Na₂SiO₃ solution.

FIG. 3: Illustrates a comparison between (a) SEM and (b) AFM image of silicate adhered to stainless steel. At pH 7, coverage of materials on the surface is rather consistent.

FIG. 4: Illustrates a) topography of plain stainless steel. b) topography taken straight after addition of silicate solution. c) topography taken after 10 mins. d) topography taken after 15 mins. e) topography taken after 20 mins Note : The height indicate the roughness of the surface—the higher the height, the rougher the surface.

FIG. 5: Illustrates the extent of fouling protein as a function of pH.

### PREFERRED EMBODIMENT(S)

The following is a description of the present invention, including preferred embodiments thereof, given in general terms. The invention is further elucidated from the disclosure given under the section “Examples” which provides experimental data supporting the invention and specific examples thereof.

The present invention generally relates to the prevention of protein fouling on surfaces. The invention is based on the discovery that over time, and under particular conditions, silicate in solution may polymerise to form structures approximately 2 to 10 nm in thickness. The inventor has surprisingly found that these structures can attach to surfaces, particularly stainless steel, effectly coating them, changing their chemistry, and reducing the affinity of proteins, or preventing protein binding, to the surfaces.

The inventor's discovery has practical application in the dairy industry where protein build-up on equipment surfaces necessitates frequent cleaning and may lower the protein content of end product including milk, for example. However, the inventors contemplate its use in any industry where protein fouling of surfaces, particuarly stainless steel surfaces, represents a problem. For example, the biotechnology industry, where protein attraction to surfaces in large scale fermentation reactions, during the production of recombinant proteins, or cell culutre, for example, may be undesirable. Other industries may include the wine and brewing industries.

In accordance with the above, the invention provides a method for preventing protein fouling of a surface comprising at least the step of placing in contact with said surface a composition comprising silicate.

In a preferred embodiment of the invention proteins are present in a complex solution or mixture, for example milk. However, the invention is applicable to prevention of fouling of proteins of any nature and in any form. For example, the protein may be in an isolated and/or purified form, or proteins may be attached to the surface of whole cells or cell membranes, or other structures, synthetic or natural. Inasmuch as this may be the case, the invention extends to preventing fouling of surfaces by whole cells, for example, bacterial cells present in fermentation reactions. These various solutions or compositions which contain proteins may be referred to herein as “composition(s) containing one or more protein(s)”.

As used herein, the term “preventing” should be taken broadly. The does not necessarily imply that proteins are completely inhibited from adhering to a surface. Accordingly, “preventing” includes at least delaying or reducing protein affinity for, or adhesion to, a surface.

In accordance with the invention a “surface” is any part of a piece of equipment which may come into contact with one or more proteins. The “surface” may comprise the entire surface which may come in contact with one or more proteins, or a part of such entire surface. In the context of the dairy industry, equipment may include for example, the plant or any individual part thereof, such as vats, vessels, pumps, tans, mixers, coolers, pipelines and the like, or equipment and vessels involved in milking or shipping dairy products such as milk. Surfaces and equipment of relevance to other industries will readily be appreciated by skilled persons. However, by way of general example, these may include bioreactors, fermentation vats and the like.

A surface in accordance with the invention is most preferably constructed of stainless steel materials. However, the inventor contemplates the invention being applicable to other metal oxide surfaces. By way of example, the invention may be applicable to surfaces constructed of Copper, Chromium, Iron or Titanium.

A composition in accordance with the invention may comprise from between approximately 0.05% to approximately 10% silicate, for example a silicate salt. In a preferred embodiment, the composition comprises approximately 0.5% to approximately 6% silicate, and even more preferably approximately 1% silicate (where %'s are expressed as weight/weight).

As will be appreciated, the content of silicate in a composition of the invention may also be expressed as a Molar (moles/L, or M) concentration; see the Examples section hereinafter. Accordingly, having regard to the Examples hereinafter, and the above mentioned preferred weight percentages of silicate, a composition of the invention preferably comprises from between approximately 0.04M to approximately 0.8M silicate. More preferably; the composition comprises between approximately 0.05M to approximately 0.6M silicate, or approximately 0.06M to approximately 0.4M silicate. In one preferred embodiment of the invention the composition comprises approximately 0.08M silicate.

Concentrations of silicate in a composition of the invention as mentioned herein, are primarily intended to refer to the concentration of monomeric silicate (SiO₄²⁻) in the composition at the time of making the composition, or as calculated on the basis of the amount of silicate which is formulated. The term “calculated silicate concentration” may be used herein to reflect this. As mentioned elsewhere herein, the nature of a composition of the invention may change with time, pH, and temperature, in that monomeric silicate in solution may polymerise or otherwise form larger structures. So, over time, or with varying pH or temperature, the concentration of free monomeric silicate may decrease. Accordingly, it should be appreciated that the invention is intended to encompass aged compositions having silicate concentrations less than 0.04M. By way of example, the inventor notes that a 1% sodium silicate solution which has aged for two weeks may have a free monomeric silicate concentration as low as approximately 0.02M.

In a preferred embodiment of the invention, the silicate is provided in the form of sodium silicate. However, alternative sources of silicate may be used. For example, alkali or alkaline-earth salts of silicates such as potassium, caesium, magnesium, or calcium, may be applicable. Person's of general skill in the art to which the invention relates may appreciate further alternative sources of silicate.

In one embodiment, the composition is an aged composition comprising silicate. As used herein an “aged” composition comprising silicate is a composition which has been allowed to sit for a period of at least 72 hours, and up to 10 weeks or more.

In another embodiment of the invention, the composition is made fresh just prior to use, or up to one to two hours before use.

In a preferred embodiment, the silicate is in solution carried by water. However, alternative diluents or carriers may be used, provided they do not interfere with the polymerisation of silicate in accordance with the invention.

In accordance with the invention, the composition has a pH between approximately 6 to approximately 10, more preferably between approximately 6.5 to approximately 8. In a particularly preferred embodiment, the composition has a pH of 7.

The pH of the composition may be adjusted using any appropriate acid compatible with the invention. By way of example, sulphuric acid, nitric acid, and hydrochloric acid may be used.

The inventors contemplate the presence of constituents other than silicate within a composition of the invention provided that they do not adversely effect the polymerisation of silicate in accordance with the invention. For example, the composition may contain various spectator ions such as sodium or potassium. Antimicrobial or sterilising agents may be included, for example silver ions. Other constituents in a composition of the invention could include arsenic, copper, or chromium, trifluoroacetic acid, or boron atoms.

In a preferred embodiment of the invention, the composition comprises approximately 1% sodium silicate in water, having a pH of approximately 7. Such a composition will have a calculated silicate concentration of approximately 0.08M.

A composition of the invention may be made in accordance with standard procedures. By way of example, a desired amount of silicate (for example a silicate salt such as sodium silicate) is dissolved in a carrier (preferably water) and the pH adjusted to that desired. Where other constituents are present in the composition they may be dissolved in the carrier prior to or after dissolution of a silicate compound.

In accordance with the invention the composition is to remain in contact with a surface for a period of time sufficient to allow coating of the surface with silicate, particularly the silicate structures of the invention. The contact time may vary depending on the temperature at which contact occurs and the concentration of silicate in solution, for example. By way of example, where the method of the invention is conducted at ambient temperature (for example, approximately 25° C.) the contact time is preferably between approximately 20 minutes and approximately 60 minutes, more preferably between approximately 25 minutes and approximately 40 minutes. In a particularly preferred embodiment of the invention the contact time is preferably approximately 30 minutes.

In accordance with the invention it is particularly desirable to have the silicate structures identified by the inventor coat an entire surface in a uniform manner. However, it should be appreciated that the benefits of the invention in preventing or reducing protein adherence to a surface may be gained where there is less than complete and uniform coating of the surface. Similarly, it should be appreciated that it may be desired to coat only a part or particular area of an entire surface.

The composition may be brought into contact with a surface by any appropriate means having regard to the surface and/or equipment to be treated. By way of example, in relation to a dairy plant, the composition may be pumped or sucked into the plant in sufficient quantity to provide adequate contact with surfaces to be treated, and allowed to remain in contact for a period in accordance with the invention.

Contact of the composition with a surface in accordance with the invention may occur at any temperature. In a preferred embodiment, contact of the composition with a surface occurs at ambient temperature (for example, approximately 25° C.). However, the inventors contemplate the invention being performed at temperatures ranging between approximately 10° C. to approximately 120° C. Such temperature range is particularly applicable to the operating environment of a milk plant, for example.

Following contact for the desired period, the composition is removed from contact with the surface. This may occur by any means appropriate in relation to the surface and/or equipment concerned. Reverting to the dairy plant example, the composition may be pumped or sucked out of the plant for example. Alternatively, the dairy plant may be flushed with water or other appropriate solution to both remove the composition, and wash the surface as described herein below.

Following removal of the composition, the surface may be washed with water or other appropriate solution to remove any composition or silicate molecules which have not adhered to the surface. The surface/equipment may then be used as designed.

The coating provided on a surface by the invention, may be removed from the surface under basic conditions. For example, a basic fluid may be placed in contact with a surface to remove the silicate coating. Such fluid may be brought into contact with a surface by any known means, including washing or flushing a surface. A basic fluid applicable to removing a coating of the invention can be a solution having a pH below 7. One preferred example is a solution containing NaOH, more preferably from approximately 0.5% NaOH to approximately 3% NaOH in water.

It will be appreciated that the frequency with which the method of the invention is conducted will vary depending on the surfaces/equipment to be treated, the industrial processes associated with such equipment, the nature of the proteins contained in material placed in contact with the surfaces/equipment during use, and the volume of material in contact with the surfaces/equipment. However, in respect of use of the invention in a dairy plant, the inventors contemplate carrying out the process in step with regular plant cleaning protocols. Dairy plants are often cleaned every 4 to 16 hours. This process involves the removal of milk, and inorganics such as calcium phosphate, organics such as lactose and bacteria by for example a 0.5% NaOH wash which may contain antimicrobial agents, followed by an acid wash, and then a water rinse. The method of the invention may be conducted immediately after such cleaning procedures.

It is noted above, that cleaning of dairy plant may occur every 4 to 16 hours. It may also be labour intensive. It is envisaged that the present invention may reduce the necessity to clean so frequently, and may also reduce labour at cleaning times. This may also be of relevance to other industries as mentioned herein before.

Protein adhesion to surfaces of industrial equipment as has been mentioned herein before, can lower heat transfer coefficients which may be particularly disadvantageous, in fermentation applications for example. This can, concomitantly, increase costs. The present invention has the advantage that prevention of protein build-up on surfaces may allow for maintenance of desirable heat transfer coefficients.

### EXAMPLES

The inventors have observed the following characteristics of silicate solutions at different pH.

TABLE 1
Effect of pH on silicate solutions

| | | Polymerisation |
|---|---|---|
| pH | Particle characteristics | rate/Stability |
| 1.5-3 | | Maximum temporary |
| | | stability with |
| | | longest gel time. |
| 5-6 | Monomeric silicate changes | Minimum stability. |
| | to particles that | Rapid gelling |
| | aggregate and gel | occurs. |
| 6/7-10.5 | Silica begins to dissolve | |
| | as silicate. The particles | |
| | are negatively charged and | |
| | repel each other. Particle | |
| | growth continues without | |
| | aggregation. | |
| 11-13 | H₃SiO₄⁻ is an active | High solubility of |
| | species in pH 12.5. | silicate particles. |
| | | No driving force for |
| | | polymerisation which |
| | | is a minimum in this |
| | | region. |

Generally, the rate of aggregation increases rapidly with concentration so that in any case, above 1% silica, aggregation probably involves not only particles but also oligomers. In addition, above pH 7, no gel is formed since particles are charged and only particle growth occurs. From the above information, tests were initially conducted using 1-% silicate solutions with pH ranges of 13-7 to investigate the anti-fouling properties of silicate solutions.

Materials and Methods

Standard Sample Surface Preparation

316 Stainless Steel samples used in the fouling experiments were embedded in epoxy resin for polishing.
The samples were polished to a final grit of 4000 grit.
Polished samples were released from the embedding resin, washed with ethanol then followed by ultrasound in distilled water then stored dry.
   Protein Fouling Treatment
   Preparation of 10% (wt/wt) of Whey Protein Isolate (WPI) Solution
10 g of WPI, Alcen 895, was dissolved in 90 g of distilled water in a beaker until the solution become homogenous.
the major component of the WPI is β lactoglobulin (40% w/w) which is believed to be the protein involved in fouling as it is denatured at elevated temperatures.
   Fouling Process
Once the WPI solution was heated to 77° C. in a water bath at temperature equilibrium, the treated samples were added to the solution.
Once the required fouling times were achieved, samples were immediately removed from the WPI solution and rinsed with distilled water to remove any loosely attached proteins.
The adhered proteins were maintained at a hydrated state and stored in a dark place to avoid any interference with light, until AFM (Atomic Force Microscope) analysis.
   Method for Measuring the Extent of Protein Fouling
AFM analysis of the surface was performed in water to ensure the protein remained hydrated. The AFM tip was used to force dissect an area of approximately 1 μm² in the fouling protein layer by applying forces that removed the protein without affecting the silicate layer.
Subsequently, the. topography of the sample across the dissected area was imaged at low force. The depth of the protein layer could be determined from the profile of the topographical image.

This procedure was repeated at different areas of the sample surface where possible to obtain an average depth of protein foulant per sample.

Silicate Treatment on Stainless Steel

Substrate used: Polished stainless steel and mica pieces.
0.0819M of SiO₂ in water was prepared by weighing 5 g of Na₂SiO₃ compound in a 500 ml distilled water.
The targeted pH was modified from 13 to 12, 10, 9, 8, 7, 6, 5, 4 and 2 using concentrated H₂SO₄.
Time of preparation of each solution was noted and a piece of stainless steel and a mica piece were immersed into the solution immediately. The treatment was conducted for 30 minutes before the substrate was taken out.
After the substrates were removed from the solution, they were rinsed with distilled water and dried.
   Three Trials of Experiment were Conducted:
   Trial 1:
Monitoring of changes in silicate structures using AFM and SEM (Scanning Electron Microscope) techniques and using stainless steel and mica as substrates.
In-Situ Visualization of silicate coatings growth onto stainless steel (at pH 8).
Extent of fouling protein of plain stainless steel as a function of time.
   Trial 2:
Measurement of extent of fouling of protein onto silicate treated stainless steel.
   Trial 3:
Measurement of extent of fouling of protein onto silicate treated stainless steel and determining the pH best at reducing fouling.
   Calculation
Reagent used:
   Na₂SiO₃
   H₂SO₄ (95-97%)
Given Na₂SiO₃ Compound:
   FW=122.06 g/mol
   SiO₂=44-47%
Required to make up: 0.0819M of SiO₂ in 1% (wt/wt) Na₂SiO₃ solution
   0.0819M=0.0819 mole/litre
      =0.0819 mole/1000 ml
      =0.00819 mole/100 ml
   Mass of Na₂SiO₃ required=moles×FW
      =0.00819×122.06
      =0.9999 g
      =1.00 g

Hence for. 500 ml of 1% (wt/wt) Na₂SiO₃ solution, 5.00 g of Na₂SiO₃ salt is required.

Results

Trial 1

Silicate Treatment on Stainless Steel and Mica

Targeted pH: 12, 10, 9, 8, 7, 6, 5, 4 and 2

Time of preparation of stock solution: 1:15 pm.

TABLE 2
pH 12-2 adjusted 1% (wt/wt)Na₂SiO₃ solution.

| | pH | | | | | | | | |
|---|---|---|---|---|---|---|---|---|---|
| Time | pH 11.97 | pH 10.14 | pH 9.06 | pH 4.08 | pH 5.02 | pH 6.02 | pH 8.02 | pH 6.97 | pH 2.04 |
| Time prepared | 1:23 pm | 1:28 pm | 1:30 pm | 1:35 pm | 1:36 pm | 1:40 pm | 1:50 pm | 1:53 pm | 1:58 pm |
| After one hour | 2:23 pm | 2:28 pm | 2:30 pm | 2:35 pm | 2:36 pm | 2:40 pm | 2:50 pm | 2:53 pm | 2:58 pm |
| (immerse samples) | | | | | | | | | |
| After 30 mins | 2:53 pm | 2:58 pm | 3:00 pm | 3:05 pm | 3:06 pm | 3:10 pm | 3:20 pm | 3:20 pm | 3:28 pm |
| (remove samples) | | | | | | | | | |
| Solution left | Clear | Clear | Clear | Clear | Cloudy | Cloudy | slight | cloudy | clear |
| 72 hrs later | Solution | Solution | Solution | solution | solution, | solution, | cloudy | solution, | solution |
| | | | | | gelation | gelation | | gelation | |
| | | | | | occurs | occurs | | occurs | |
| | | | | | | (most) | | | |

Note:
Structures of silicates may change with time. For this experiment, change in structures was monitored as a function of pH.

ATM Scan on Treated Mica Samples

Mode of AFM used: Contact Mode in Air

TABLE 3
Tabulation of results from AFM scan of silicate
treated mica samples (pH 12-2).

| | Scan Size | |
|---|---|---|
| pH | (micron)² | Remarks |
| 12 | 10 | No distinctive structures observed |
| 10 | 1 | Not much material was observed. |
| | | Surface looked rather clean |
| 9 | 10 | Cyclic or branched structures were observed |
| | 1 | Lots of round blobs noticed. They may be are joined |
| | | together to form the coverage on the surface. |
| 8 | 10 | Lots of loose materials were observed on the |
| | | surface |
| 7 | 10 | Not much materials appeared on the surface |
| | | Drifting particles were noticed on the surface. |
| 6 | 10 | Lots of materials on the surface seem to be moved |
| | | by the tip |
| 5 | 10 | Lots of moving material on the surface |
| | 4 | An approximately 500 nm long cylindrical shaped |
| | | particle was noticed |
| 4 | 10 | Little particles were noticed and seem to be moved |
| | | by the tip |
| 2 | 10 | Lots of moving particles were observed |

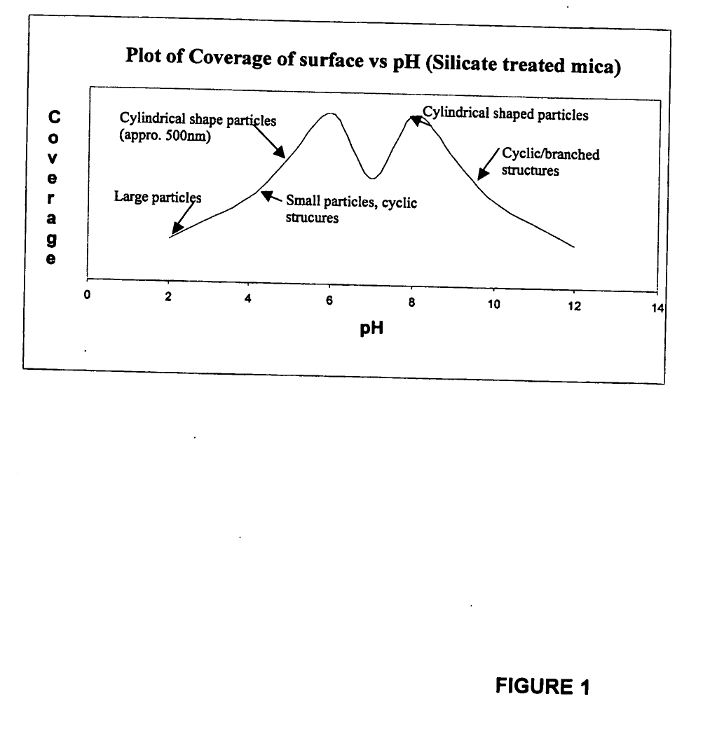

Analysis of Silicate Treated Mica Results
It was noticed that the amount of materials coated on the surface did not follow a linear trend as a function of pH. This is depicted by the graph as shown in FIG. 1.
The shape of the curve was roughly sketched out by comparing the images taken at the different pH (12-2) at scan size of 10 μm².
on the whole, results obtained have shown that the structure of silicate changes as a function of pH.
   AFM Scan on Silicate Treated Stainless Steel Samples

Mode of AFM used: Contact Mode in Air.

TABLE 4
Results of AFM scan of silicate treated
stainless steel samples (pH 12-2).

| | Scan Size | |
|---|---|---|
| pH | (micron)² | Remarks |
| 12 | 10 | Not much coverage of materials was noticed. Polishing |
| | | lines of stainless steel can be seen quite obviously. |
| | | Particles noticed on the surface were somewhat |
| | | cylindrical in shape. |
| 10 | 10 | Not much coverage of materials was noticed. Polishing |
| | | lines of stainless steel can be seen quite obviously. |
| | | Particles noticed on the surface were somewhat |
| | | cylindrically shaped. |
| 9 | 10 | Lots of materials were noticed on the surface. Round |
| | | particles were noticed on the coverage of substrate. |
| 8 | 10 | Lots of material was noticed on the surface. |
| | 5 | Spherical particles were noticed. They seemed to be |
| | | joining together to form lumps. |
| 7 | 10 | Lots of materials were on the surface. Polishing |
| | | lines were not seen. |
| | 5 | Coverage material seem to be formed by cylindrical |
| | | shaped particles joined together. |
| 6 | 10 | Lots of materials were noticed. But not as much as |
| | | pH 7. |
| | 2 | Cylindrical shaped particles with dimension of 100 |
| | | nm width and 500 nm length was noticed. They seem to |
| | | be joining together to form the coverage on the |
| | | stainless steel. |
| 5 | 10 | Loosely bounded particles on the surface were |
| | | observed. |
| | 7.4 | Huge cylindrical shaped particle with dimension of |
| | | 350 nm width by 500 nm height was noticed. |
| 4 | 10 | Lots of materials on the surface were noticed. |
| | | Amount of particles observed seem to be lesser as |
| | | compared with pH 5. |
| | 5 | Loosely bounded cylindrical shaped particles were |
| | | observed. Coverage on the material can be dissected |
| | | by tip as smaller area that was previously scanned |
| | | has been cleared. |
| 2 | 10 | Not much coverage of materials was noticed on the |
| | | surface. Surface looked clean as polishing lines of |
| | | the stainless steel can be seen rather obviously. |

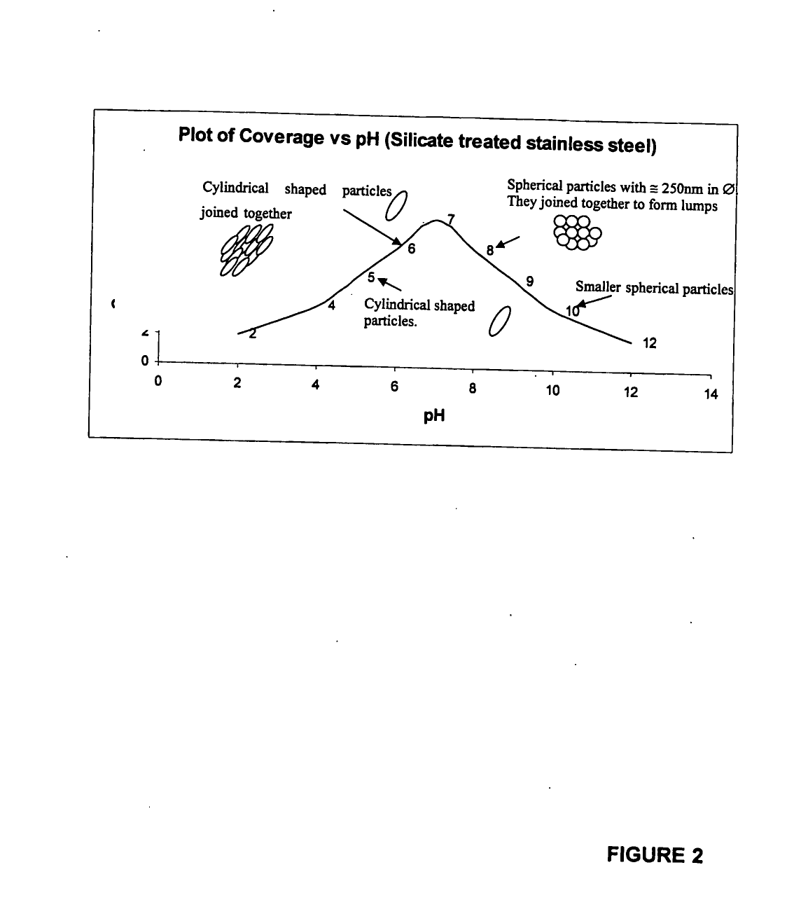

Analysis of Silicate Treated Stainless Steel
Similar to treated mica samples, the amount of materials coated on the surface did not follow a linear trend as a function of pH. A maximal point on the graph was observed for pH 7 and this is depicted by the graph as shown in FIG. 2.
However, the plot of Materials Coverage versus pH of Na₂SiO₃ solution for silicate treated stainless steel was different from the silicate treated mica samples.
The difference arises from pH 7 which shows maximum coverage of materials on the curve instead of a minimum which was observed from the mica samples.
At lower pH, cylindrical shaped looking particles were noticed.
As the pH of the solution increases, fewer cylindrically shaped particles were noticed. In another words, particles were more spherically shaped.
   SEM Image on Silicate Treated Stainless Steel Samples

Source of sample: Silicate treated stainless steel prepared seven days prior to this analysis as per the protocols previously described herein.

TABLE 5
Tabulation of results from SEM experiment.

| pH of | Magni- | |
|---|---|---|
| Na₂SiO₃ | fication | Observation |
| 2 | ×500 | Not much material was observed on the surface. |
| | | Polishing lines can be seen. |
| 4 | ×500 | Lots of particles can be seen on the surface. |
| | | Dendrites looking thing was observed. |
| 5 | ×230 | A lot of crystallized material was noticed on |
| | | the surface. Dendrites looking thing was |
| | | observed. |
| | ×500 | This micrograph looked different from the one |
| | | taken at ×230 magnification. No dendrites was |
| | | observed. Domains were noticed on the surface. |
| 6 | ×500 | Image looked different from pH 2, 4 and 5. |
| | | There was not much material on the surface |
| | | observed. |
| 7 | ×500 | Coverage of materials on the surface was |
| | | consistent |
| 8 | ×550 | Not much material was noticed on the surface. |
| 9 | ×500 | Large particles were noticed, some |
| | | inconsistency of coverage. |
| 10 | ×500 | Image looked very different from the rest of |
| | | the pH. As no polishing lines were observed, |
| | | surface might to be coated by a layer of |
| | | materials. |
| 12 | ×500 | Surface looked rather clean. |

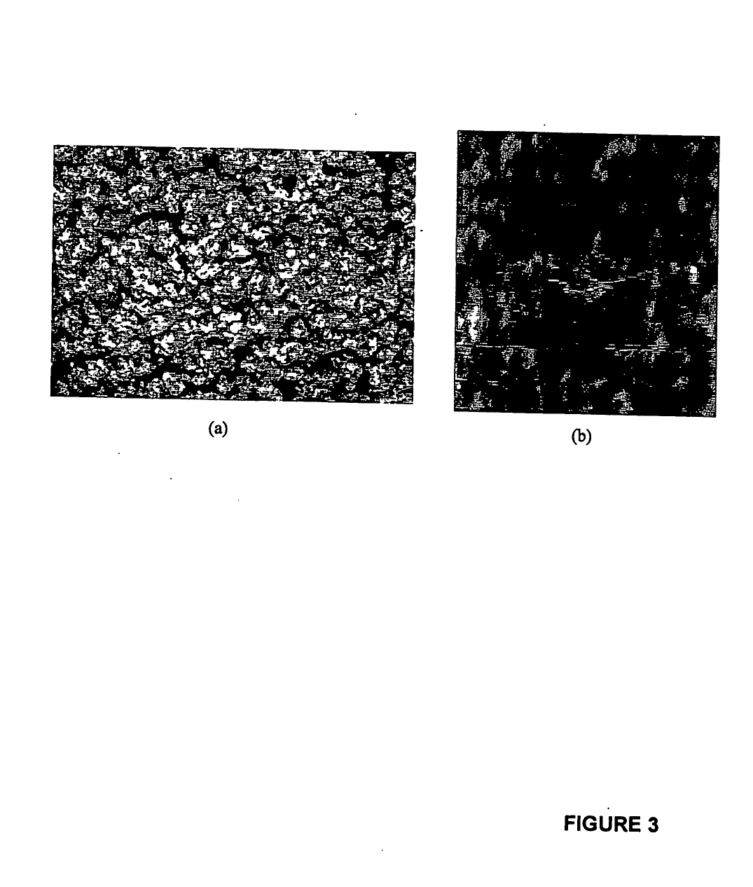

As seen FIG. 3, at pH 7, coverage of materials on the surface is rather consistent.

Scanning Electron Microscope Analysis of Silicate Treated Stainless Steel

The surface coverage of the silicate treated stainless steel samples in terms of consistency of materials coverage as a function of pH were imaged by Scanning Electron Microscope (SEM). The treated solution ranges from pH 12-2 of Na₂SiO₃ solutions. The treated samples used were prepared seven days prior to this analysis as per the protocols previously described herein.

The purpose of running this experiment was to differentiate the image of each sample in terms of the consistency of materials coverage on the surface. From the results, it can be concluded that treatment done at different pH would result in a different outcome of materials coated on the stainless steel.

In Situ AFM Visualization of Silicate Coatings Growth onto Stainless Steel (at pH 8)

The AFM was used to obtain a three-dimensional image of the surface of solids with the nanometer-scale resolution in liquid and thus to observe the transformation of the surface treated with silicate solution at pH 8 in situ in the real-time scale. This allowed the inventor to obtain data about the growth of silicate materials onto stainless steel with time.

The AFM measurements were made in a tapping mode directly in situ in the silicate solution at pH 8. AFM images were obtained from the same surface area one-by-one at every 5 minutes interval during its materials deposition with time.

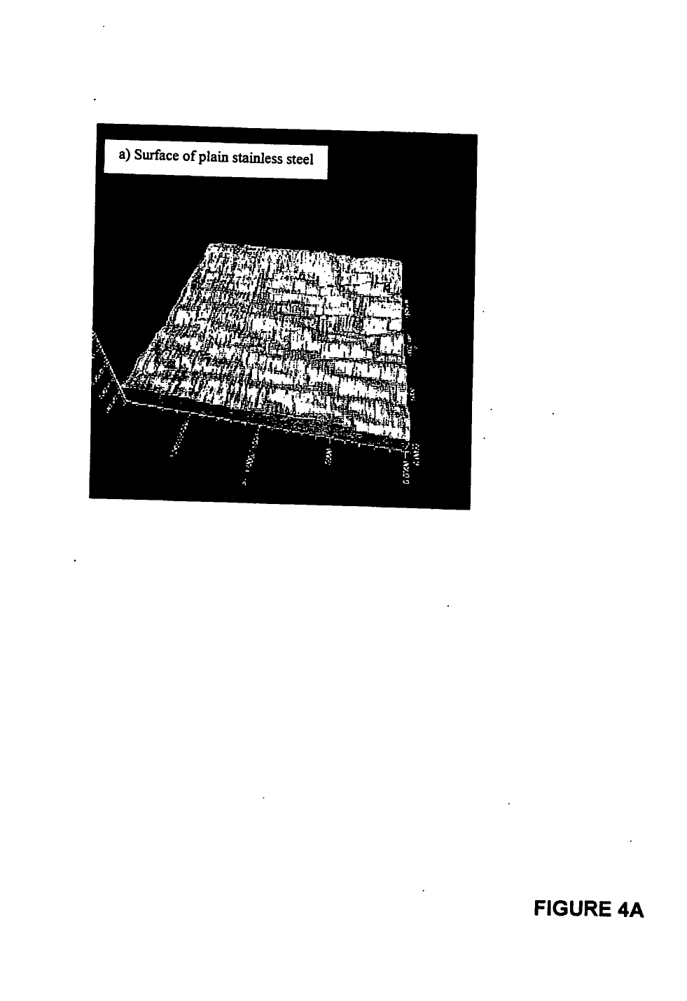

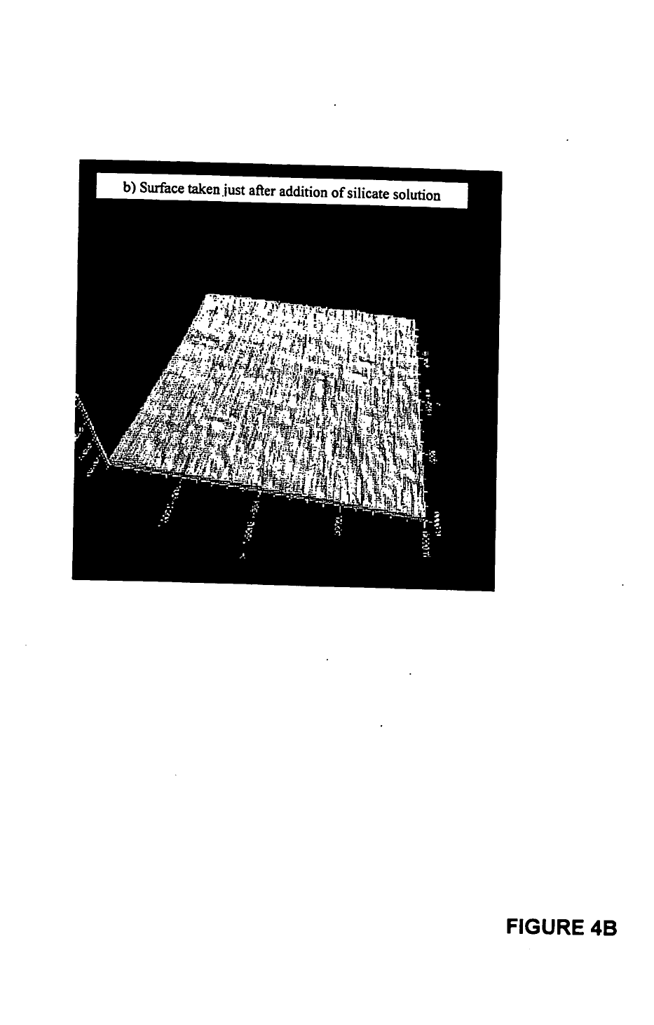

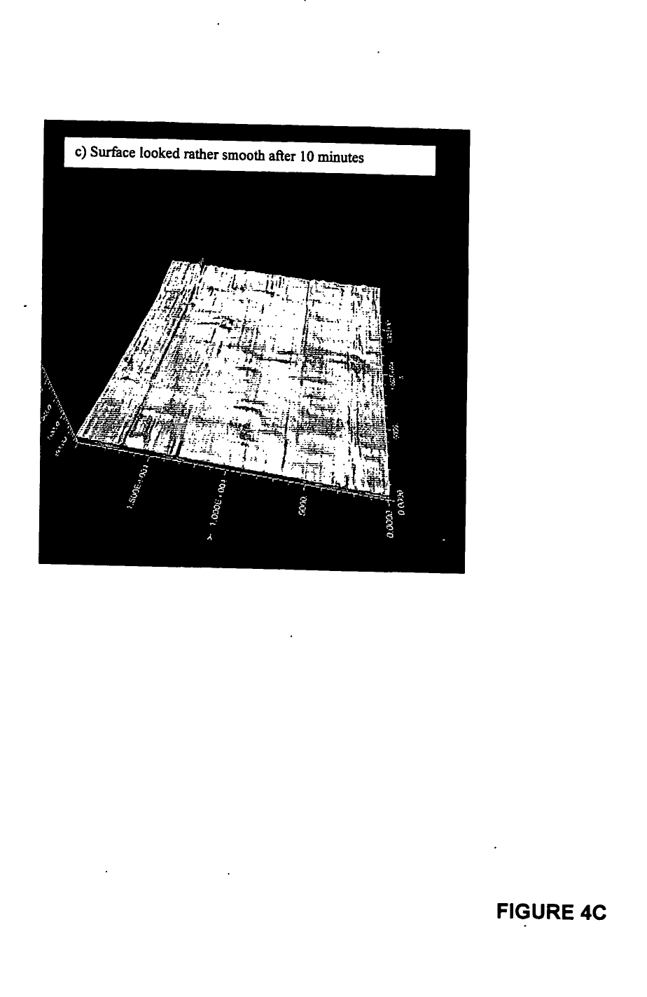

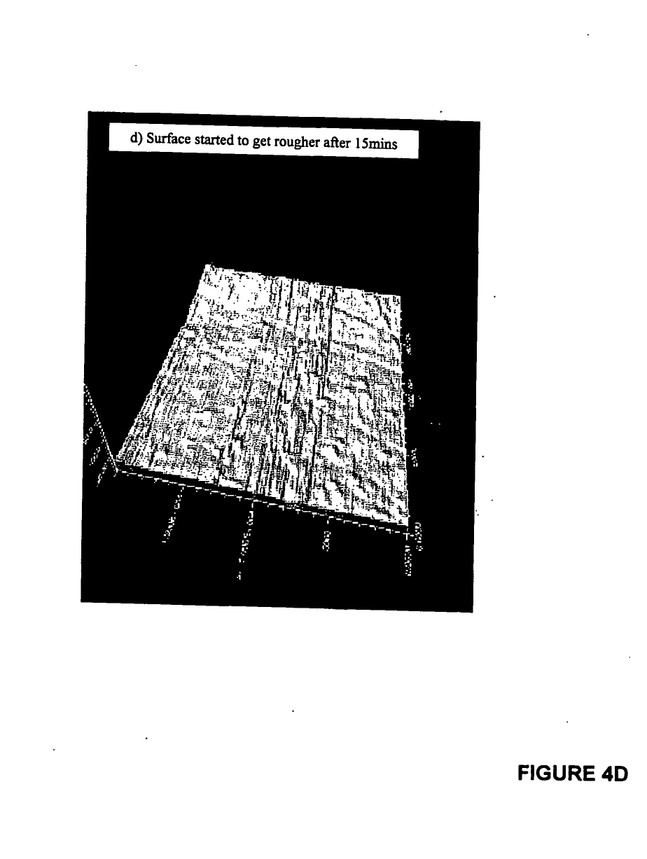

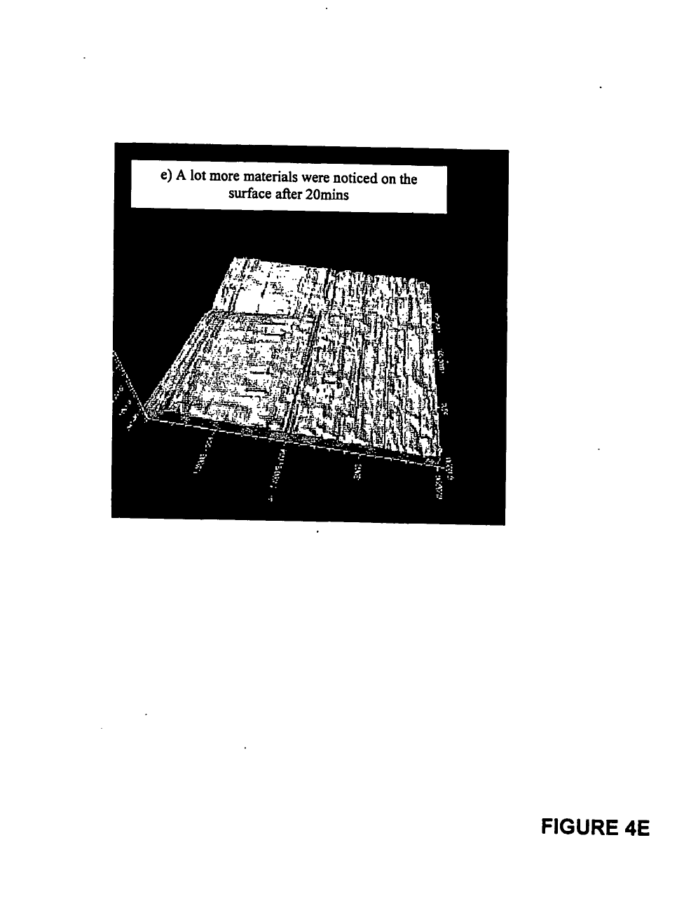

The experimental results are shown in FIG. 4(a) to (e).

AFM Scan Fouling of Untreated Stainless Steel Samples

Mode of AFM used: Contact Mode in water
   Trial Using Short Cantilever

Analysis of fouling of untreated stainless steel samples.

TABLE 6
Tabulation of results for the extent of protein fouling

| Fouling regime | Estimated depth (nm) | Remarks |
|---|---|---|
| 10 mins | 8 | Fouling image observed. |
| | | Dissected area seen |
| 20 mins | 10 | Fouling image observed. |
| | | Dissected area seen. |
| 30 mins | 12-15 | Fouling image observed. |
| | | Dissected area seen. |

Results obtained from fouling samples show that the amount of proteins deposited on the stainless steel increased with fouling time.

Trial 2

AFM Scan Fouling of Silicate Treated Stainless Steel Samples

Mode of AFM used: Contact Mode in water
Initial studies conducted in respect of the fouling of protein on silicate treated stainless steel samples indicated that the force used to dissect surface material had an effect on the results obtained. For example, when increased force was applied not only was the protein fouling layer removed but also the underlying silicate coating. In light of this, additional analyses were conducted, for example using profiles obtained from AFM where different forces were applied, to ensure studies were conducted using consistent force of scraping, and thus accurate measurements of protein fouling were generated.
   Trial 3
   Silicate Treatment on Stainless Steel

Time of preparation of stock solution:1:53 pm

TABLE 7
pH 9-5 adjusted 1% (wt/wt)Na₂SiO₃ solution

| | pH | | | | |
|---|---|---|---|---|---|
| Time | 9 | 8 | 7 | 6 | 5 |
| Time of | 2:08 | 2:12 | 2:14 | 2:16 | 2:17 |
| preparation | | | | | |
| 1 hour | 3:08 | 3:12 | 3:14 | 3:16 | 3:17 |
| after | | | | | |
| immersion | | | | | |
| of sample | | | | | |
| Removal of | 3:38 | 3:42 | 3:44 | 3:46 | 3:47 |
| sample | | | | | |
| after 30 | | | | | |
| minutes | | | | | |
| Appearance | Clear | Clear | Slightly | Slightly | Clear |
| of solution | | | Cloudy | less | |
| after 1 | | | after | cloudy | |
| hour | | | 1 hour | than pH 7 | |
| Appearance | | Solution becomes cloudy | | | |
| of solution | Clear | Least | Most | 2nd most | 3rd most |
| after 24 | | cloudy | cloudy | cloudy | cloudy |

| hours | No gelation | Gelation of solution observed | | |
|---|---|---|---|---|
| | observed | Most | 2nd most | least |
| | | gelation | gelation | gelation |

AFM Scan on Silicate Treated Steel Samples

Mode of AFM used: Contact Mode in water

TABLE 8
Results of AFM scan of silicate treated stainless
steel samples (pH 9-5) and a control sample)

| Treatment | Depth (nm) | Remarks |
|---|---|---|
| Control Sample | 6 | |
| pH 9 | 6 | |
| pH 8 | — | Dissected area not seen |
| pH 7 | — | Dissected area not seen |
| pH 6 | 13-15 | |
| pH 5 | 10 | |

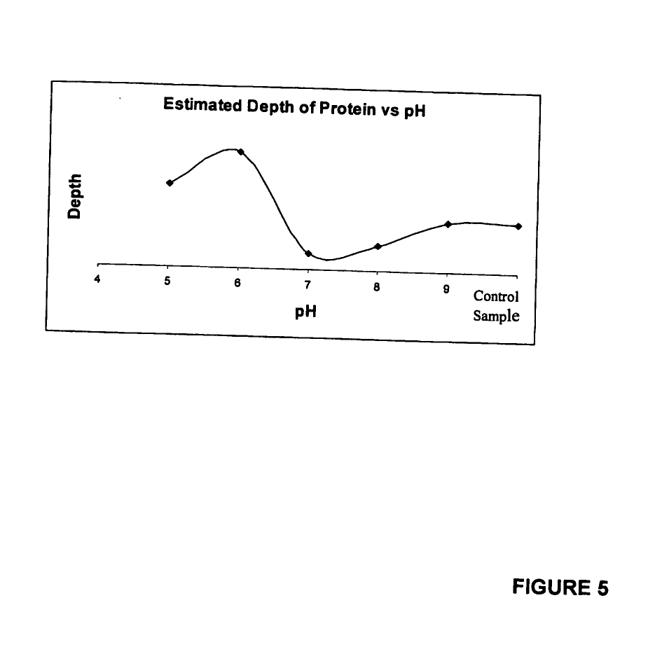

Trial 3 results, as seen in FIG. 5, show that the best performance of anti-fouling of protein on treated stainless steel was found to be around pH 7.

Discussion

For Trial 1, changes in structure of silicate as a function of pH was determined. Also, in situ imaging of silicate solution at pH 8 using tapping mode showed that the silicate solution changes with time. The studies conducted on mica are not indicative of those on metal oxide surfaces, for example stainless steel. However, they allowed the inventor to analyse the changes in silicate solution structure as a function of time and/or pH.

Trials 2 and 3 indicated that the characteristics of a surface may influence protein absorption and removal. Treatment of stainless with silicate solution was done at different pH and the extent of fouling of protein was determined as a function of pH. It was found that silicate treated stainless steel showed significantly different adsorption or desorption of protein during fouling. The trials indicated that the sample treated at around 7 gave the most consistency in terms of materials coverage and enhanced anti-fouling properties as compared with the rest of the pH used to treat the stainless steel. However, it should be appreciated that a pH within the range of approximately 6 to approximately 10 may find use in the present invention.

The invention has been described herein with reference to certain preferred embodiments, in order to enable the reader to practice the invention without undue experimentation. Those skilled in the art will appreciate that the invention is susceptible to variations and modifications other than those specifically described. It is to be understood that the invention includes all such variations and modifications. Furthermore, titles, headings, or the like are provided to enhance the reader's comprehension of this document, and should not be read as limiting the scope of the present invention.

The entire disclosures of all applications, patents and publications, cited above and below, if any, are hereby incorporated by reference.

The reference to any prior art in this specification is not, and should not be taken as, an acknowledgment or any form of suggestion that that prior art forms part of the common general knowledge in New Zealand or any other country.

Throughout this specification, and any claims which follow, unless the context requires otherwise, the words “comprise”, “comprising” and the like, are to be construed in an inclusive sense as opposed to an exclusive sense, that is to say, in the sense of “including, but not limited to”.

1. A method for preventing protein fouling of a surface comprising at least the step of placing in contact with the surface a composition comprising silicate to allow a silicate coating to form on the surface.

2. A method as claimed in claim 1 wherein the composition has a pH between approximately 6 to approximately 10.

3. A method as claimed in claim 2 wherein the composition has a pH of 7.

4. A method as claimed in claim 1 wherein the composition has a calculated silicate concentration from approximately 0.04M to 0.8M.

5. A method as claimed in claim 4 wherein the composition has a calculated silicate concentration of approximately 0.08M.

6. A method as claimed in claim 1 wherein the composition and the surface are placed in contact at a temperature of between approximately 10 C to approximately 120 C.

7. A method as claimed in claim 6 wherein the composition is placed in contact with the surface at ambient temperature.

8. A method as claimed in claim 1 wherein the composition is allowed to remain in contact with the surface for a period of time sufficient to allow coating of the surface with silicate.

9. A method as claimed in claim 8 wherein the composition is allowed to remain in contact with the surface for a period of at least from approximately 20 minutes to approximately 60 minutes.

10. A method as claimed in claim 9 wherein the composition is allowed to remain in contact with the surface for a period of at least approximately 30 minutes.

11. A method as claimed in claim 1 wherein the surface is constructed of a metal oxide.

12. A method as claimed in claim 11 wherein the surface is stainless steel.

13. A method as claimed in claim 1 wherein the surface is on equipment used in the dairy industry.

14. A method as claimed in claim 1 wherein the method further comprises the step of washing the composition from contact with the surface.

15. A method as claimed in claim 14 wherein water is used to wash the composition from contact with the surface.

16. A method as claimed in claim 1 wherein the method is for preventing protein fouling by a composition containing one or more proteins.

17. A method as claimed in claim 16 wherein the composition containing one or more proteins is milk.

18. A method of processing a composition containing one or more proteins, the method comprising at least the steps of: a) preparing a surface of any equipment in accordance with a method of any one of claims 1 to 17; and, b) processing with the equipment the composition containing one or more proteins.

19. A method as claimed in claim 18 wherein the composition containing one or more proteins is milk.

20. A method as claimed in claim 18 wherein the surface of the equipment is constructed of a metal oxide.

21. A method as claimed in claim 20 wherein the surface of the equipment is stainless steel.

22. A composition for preventing protein fouling on a surface, the composition having a calculated silicate concentration of at least approximately 0.04M to approximately 0.8M, and having a pH between approximately 6 to approximately 10.

23. A composition as claimed in claim 22 wherein the composition has a calculated silicate concentration of approximately 0.08M.

24. A composition as claimed in claim 22 wherein the silicate is provided in the form of a salt.

25. A composition as claimed in claim 24 wherein the salt is sodium silicate.

26. A composition as claimed in claim 22 wherein the composition has a pH of approximately 7.

27. The use of silicate, or a salt thereof, in the manufacture of a composition for the prevention of protein fouling on a surface.

28. The use as claimed in claim 27 wherein an amount of silicate or a salt thereof is sufficient to provide from between approximately 0.04M to approximately 0.8M silicate in the composition.

29. The use as claimed in claim 28 wherein the amount of silicate or a salt thereof is sufficient to provide approximately 0.08M silicate in the composition.

30. The use as claimed in claim 27 wherein at least approximately 0.05% to approximately 10% silicate or a salt thereof is used.

31. The use as claimed in claim 30 wherein approximately 1% silicate or a salt thereof is used.

32. The use as claimed in claim 27 wherein the salt is sodium silicate.

33. The use as claimed in claim 27 wherein the surface is constructed of a metal oxide.

34. The use as claimed in claim 33 wherein the surface is stainless steel.
